(19) United States
(12) Patent Application Publication
(10) Pub. No.: US 2026/0231871 A1
(43) Pub. Date: Aug. 13, 2026

(54) PLANT TETHER

(71) Applicant: Patrick ROME, El Paso, TX (US)

(72) Inventor: Patrick ROME, El Paso, TX (US)

(21) Appl. No.: 19/156,380

(22) PCT Filed: Feb. 14, 2024
(86) PCT No.: PCT/US2024/015757

§ 371 Date: Aug. 13, 2025

Related U.S. Application Data
(60) Provisional application No. 63/445,398, filed on Feb. 14, 2023.

(51) Int. Cl. A01G 17/04

(52) U.S. Cl. CPC A01G 17/04

(57) ABSTRACT

A system comprises a hanging strap, the hanging strap further comprising a plurality of layers and at least one slot formed in a body of the hanging strap and a field compostable soil sealing barrier configured to retain soil moisture and prevent weed growth.

### CROSS REFERENCE TO RELATED PATENT APPLICATIONS

The present application claims the priority and benefit under 35 U.S.C. § 119(e) of U.S. Provisional Patent Application Ser. No. 63/445,398, filed Feb. 14, 2023, entitled “PLANT TETHER.” U.S. Provisional Patent Application Ser. No. 63/445,398 is herein incorporated by reference in its entirety.

### TECHNICAL FIELD

Embodiments disclosed herein are related to plant supports and grow tethers. Embodiments are further related to soil sealants. Embodiments are further related to reusable straps, tethers, and soil sealants. Embodiments are further related to grow supports having slits to allow zip straps to be connected thereto. It is one aspect of the present embodiments to provide a compostable plant support. Embodiments are further related to field compostable plant supports configured to work with zip strap tethers to support plant growth.

### BACKGROUND

Many plants require a structure to grow properly. For example, certain plants require a plastic rope and metal wire, lattice, pole, or other such structure, to allow the product to “train” it's way up the structure and achieve healthy growth.

Traditional systems and methods for growing such products make use of metal or plastic grow rope and metal wire, with metal or plastic ties or fittings to help train the plant up the grow rope. These systems are effective during the growth of the plant, but create major disadvantages after the grow season.

For example, after the plant has grown, and the plant yield is harvested, the grow ropes and wires, and/or fittings are left in a heap, with the remaining compostable plant material. In order to safely use the composted plant material, the heap has to be carefully separated to remove any inorganic materials. Shredding machines used to sift the heap can be damaged by metal or plastic remnants in the stack. In some cases, special machinery, or even manual removal, is required. At scale, this creates a massive inefficiency which requires many hours and resources.

Therefore, a need exists for a strong compostable grow support, as described by the embodiments disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is one aspect of the present embodiments to provide a grow support.

It is another aspect of the present embodiments to provide a soil sealing barrier.

It is another aspect of the embodiments to provide a field compostable soil sealing barrier along with a compostable grow support, configured to engage plants with compostable or field compostable straps and tethers.

It is another aspect of the embodiments to provide a grow support system which can be shredded and composted. For example, in certain embodiments, a system comprises a hanging strap the hanging strap further comprising: a plurality of layers, at least one slot formed in a body of the hanging strap, and a field compostable soil sealing barrier. In an embodiment, the plurality of layers comprise a carrierboard, silica threads laminated on the carrierboard with a compostable pressure sensitive adhesive, and a corn-based film. In an embodiment, the carrierboard comprises an Aqua-Kote Carrierboard. In an embodiment, the field compostable soil sealing barrier comprises paper stock, a corn based PLA film, and a hotmelt adhesive. In an embodiment, the field compostable soil sealing barrier further comprises at least one hole formed in the field compostable soil sealing barrier. In an embodiment, the system further comprises a zip strap configured to engage the at least one slot.

The strapping and the sealant can be collected together with the chopping equipment making a complete compostable solution for the hanging application. The chopper will collect the soil sealant off the ground along with strapping and plant material which can be chopped up and shot it into a container that can transport to a compost area.

in certain embodiments, a system comprises a hanging strap the hanging strap further comprising: a plurality of layers, at least one slot formed in a body of the hanging strap, and a field compostable soil sealing barrier. In an embodiment, the plurality of layers comprise: a carrierboard, silica threads laminated on the carrierboard with a compostable pressure sensitive adhesive, and a corn-based film. In an embodiment, the carrierboard comprises an Aqua-Kote or Carrierboard. In an embodiment, the field compostable soil sealing barrier comprises paper stock, a corn based PLA film, and a hotmelt adhesive. In an embodiment, the field compostable soil sealing barrier further comprises at least one hole formed in the field compostable soil sealing barrier. In an embodiment, the system further comprises a zip strap configured to engage the at least one slot.

In an embodiment a system comprises a hanging strap the hanging strap further comprising a connector end configured to engage with an overhead structure; a plurality of biodegradable and/or compostable layers; and a plurality of slots formed in a body of the hanging strap. In an embodiment, the plurality of biodegradable and/or compostable layers comprise a carrierboard, silica threads laminated on the carrierboard with a compostable pressure sensitive adhesive, and a corn-based film. In an embodiment, the carrierboard comprises Aqua-Kote or Carrierboard. In an embodiment, the system further comprises a zip strap configured to engage the at least one slot. In an embodiment, the zip strap further comprises a biodegradable and/or compostable material. In an embodiment, the system further comprises a field compostable soil sealing barrier comprising a plurality of biodegradable and/or compostable layers. In an embodiment, the field compostable soil sealing barrier comprises paper stock, a corn based PLA film, and a hotmelt adhesive. In an embodiment, the field compostable soil sealing barrier comprises paper stock, and a clay coating. In an embodiment, the field compostable soil sealing barrier further comprises a natural oil coating applied to at least one of the plurality of biodegradable and/or compostable layers. In an embodiment, the system further comprises at least one cutout formed in the field compostable soil sealing barrier.

In another embodiment, a system comprises a field compostable soil sealing barrier comprising a plurality of biodegradable and/or compostable layers. In an embodiment, the field compostable soil sealing barrier comprises paper stock, a corn based PLA film, and a hotmelt adhesive. In an embodiment, the field compostable soil sealing barrier comprises paper stock and a clay coating. In an embodiment, the field compostable soil sealing barrier further comprises a natural oil coating applied to at least one of the plurality of biodegradable and/or compostable layers. In an embodiment, the system comprises at least one cutout formed in the field compostable soil sealing barrier.

In another embodiment, a system comprises a hanging strap the hanging strap further comprising: a connector end configured to engage with an overhead structure, a plurality of layers, a plurality of slots formed in a body of the hanging strap, and a field compostable soil sealing barrier with at least one cutout formed in the field compostable soil sealing barrier; and a zip strap configured to engage the at least one slot. In an embodiment, the plurality of layers comprise a carrierboard, silica threads laminated on the carrierboard with a compostable pressure sensitive adhesive, and a corn-based film. In an embodiment, the field compostable soil sealing barrier comprises paper stock, a corn based PLA film, and a hotmelt adhesive. In an embodiment, the field compostable soil sealing barrier comprises paper stock and a clay coating. In an embodiment, the field compostable soil sealing barrier further comprises a natural oil coating applied to at least one of the plurality of biodegradable and/or compostable layers.

Other objects and advantages of the present invention will become apparent from the following detailed description when viewed in conjunction with the accompanying drawings, which set forth certain embodiments of the invention.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

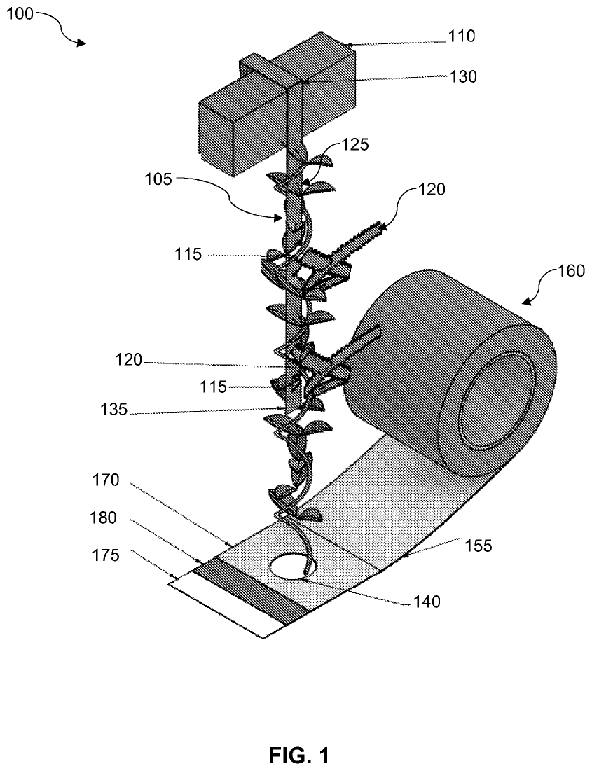

### FIG. 1 depicts a hanging grow strap system, in accordance with the disclosed embodiments;

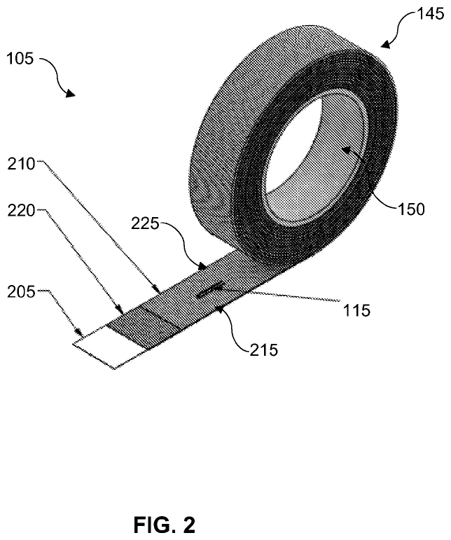

FIG. 2 depicts aspects of the hanging grow strap system, in accordance with the disclosed embodiments;

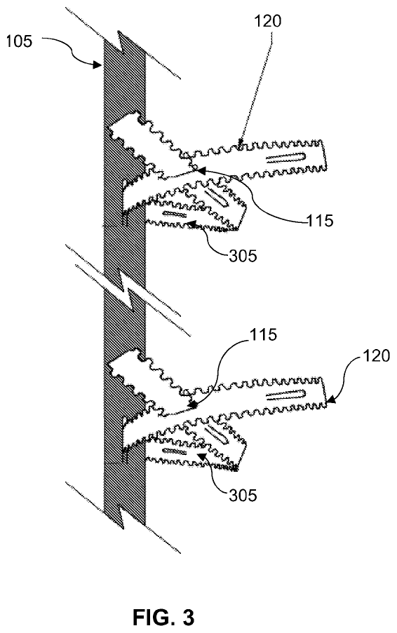

FIG. 3 depicts zip straps connected to a hanging grow strap, in accordance with the disclosed embodiments;

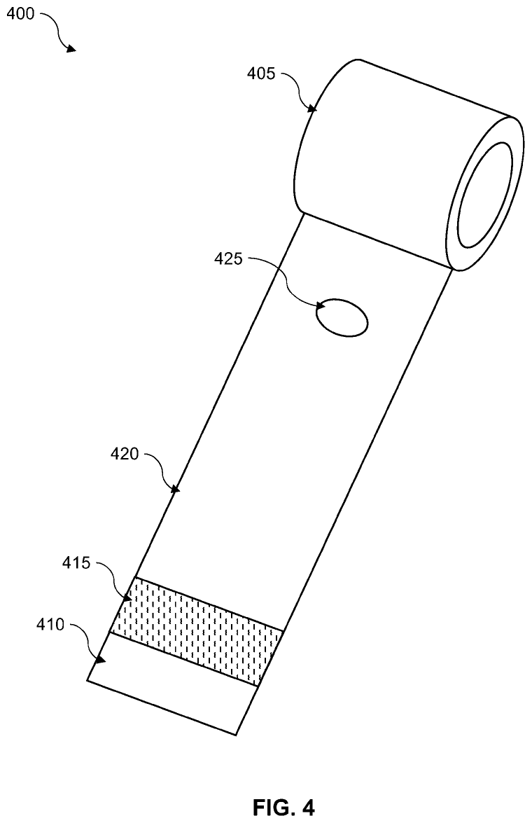

FIG. 4 depicts aspects of a soil sealing and weed preventing barrier, in accordance with the disclosed embodiments;

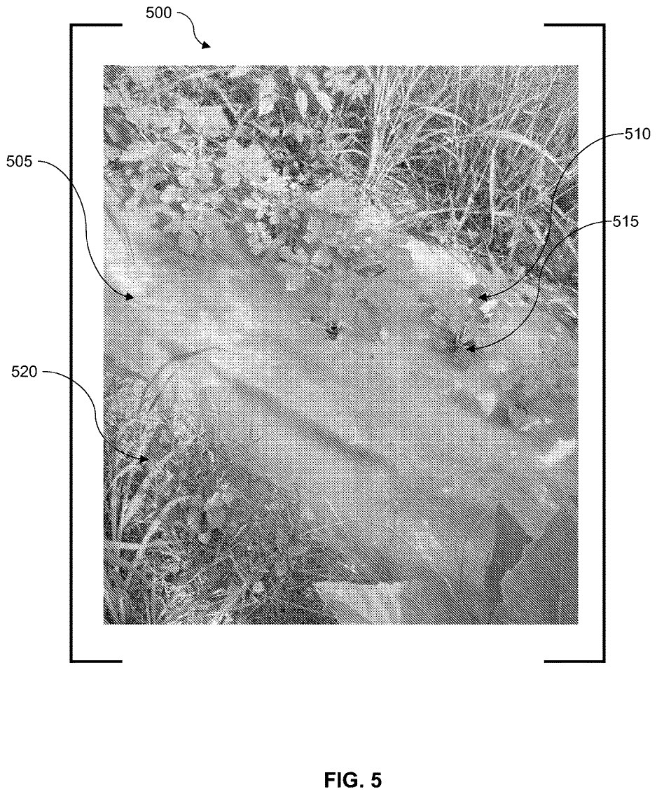

FIG. 5 depicts an image of a soil sealing and weed preventing barrier, in accordance with the disclosed embodiments; and

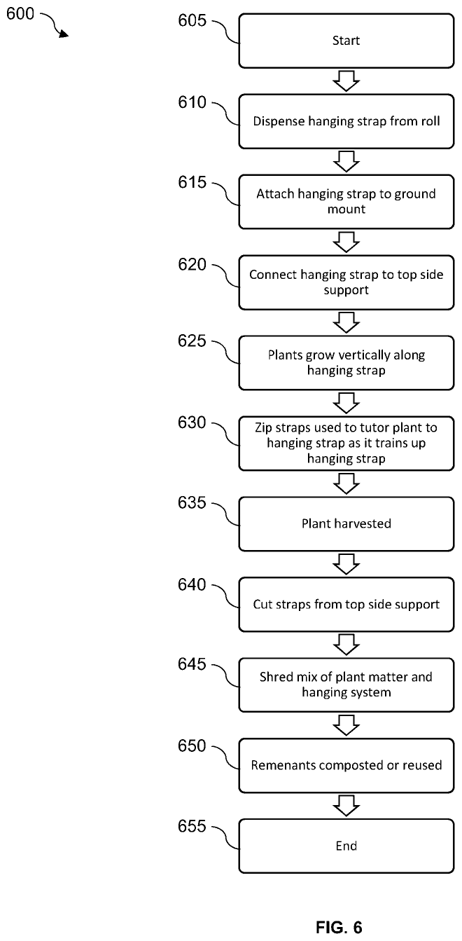

FIG. 6 depicts steps associated with a method of using the disclosed systems, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

U.S. Pat. No. 8,176,599, titled “CINCHING AND BUNDLING TIE” filed Mar. 1, 2010, describes a cinching and bundling tie. U.S. Pat. No. 8,176,599 is herein incorporated by reference in its entirety.

International Patent Application Number PCT/US2021/035309, titled “ZIP STRAP TETHER” filed Jun. 1, 2021, describes a tie. International Patent Application Number PCT/US2021/035309 is herein incorporated by reference in its entirety.

The disclosed embodiments are directed to a growing support system that can be collected and shredded with readily available agricultural chopping equipment. The entire system can be easily cut or released from an overhead plant support wire or bar in vertical growing systems. Once removed from the plant, the hanging system can be cut free from the overhead hanging frame. In some cases, this is accomplished with a branch trimmer/saw combo set on a non-powered pole saw. The entire plant, along with the hanging system and soil sealing system can be collected with common equipment, and shredded so that it can be moved back to a field or into a bin for transmission to a compost area.

FIG. 1 illustrates an embodiment of a plant growing system 100. The plant growing system 100 can comprise a hanging grow strap 105 configured to engage a support 110. In general, the support can be a ceiling beam, roof rafter, hanging line, pole, lattice, attachment in a greenhouse, outdoor hanging line, or any other such overhead support. The grow strap 105 can include a connector end 130 used to engage the support 110. The system further includes a field compostable soil sealing barrier 155.

The hanging grow strap 105 can include one or more slots 115. The slots 115 can comprise an elongated oval shaped cut in the center body 125 of the grow strap 105. At the connector end 130, the grow strap 105 can include a cutout so that the tag end can be laced through the cutout around an overhead support in order for it to be connected to the overhead support. The grow strap can also be tied around the overhead support, or otherwise bound to the overhead support. It should be appreciated that, in other embodiments, the shape of the slot can be selected to match an associated strap as further detailed herein.

The slots 115 can be spaced at intervals along the grow strap 105. In an exemplary embodiment, the slots 115 can be between 1 and 2 feet apart, although in other embodiments, other spacing can be used. The slots 115 are configured to accept zip straps 120, which can be field compostable zip straps 120. The purpose of the slots 115 is to run a field compostable zip strap through the slots 115 in order to secure the plant 135 to the grow strap 105, and/or tutor the plant 135 along the grow strap 105 at different intervals. As the plant 135 is twisted around the strap the zip strap can be used to keep the leading edge of the plant 135 heading up the grow strap 105.

The system 100 can further include a soil sealing barrier 155. The soil sealing and weed preventing barrier 155 can comprise a roll of layered material 165 for placing on the ground below the grow strap 105. In other embodiments, the soil sealing barrier can be used without the grow strap 105.

The soil sealing barrier 155 can generally be provided as a roll 160 of material, and can have a width from a few inches up to a few meters depending on the spacing required for the associated plants.

The layered material 165 can include paper stock 170, and a corn based polylactic acid (PLA) film 175 bound with a compostable hotmelt adhesive 180. The materials in the layered material 165 are selected to be biodegradable and/or compostable.

In certain embodiments, a hole 140 can be formed in the soil sealing barrier, where the plant 135 will be planted. In certain embodiments the roll 160 of layered material 165 can have multiple spaced holes, or holes can be punched in the layered material 165 at the desired spacing. Perforations can be provided at various locations along the layered material 165, to ease the job of making holes.

FIG. 1 illustrates the material 165 with layers including a paper stock 170 comprising carrierboard laminated on both sides with compostable pressure sensitive adhesive 180 and corn-based film 175. This material 165 is designed for interior or exterior applications.

FIG. 2 illustrates aspects of the grow strap 105 in accordance with the disclosed embodiment. In an embodiment, the grow strap 105 includes at least three layers. One layer can comprise a corn based Polyactic Acid (PLA) film 205 laminated to a 1S clay coated wet strength paper 210 (such as Aquakote or Carriercoat) with a clay coating 215 on the opposite side to the film 205 with a hotmelt adhesive 220.

Between this sandwich of materials, are a large number of silica threads 225 that run continuously the length of the strap 105. In an exemplary embodiment, between 10 to 25 threads per inch of width of the strap 105 can be provided. In certain embodiments the silica thread 225 can be composed of smaller silica threads which can be designed to meet the strength and dimensional criteria required for the construction and various required strengths of straps. The threads can have a 2 to 3 pound tensile strength which gives the strap 105 tensile strength equal to plastic rope, to hang heavy plant growth and produce vertically. In other embodiments, other strength threads can be used.

In an exemplary embodiment, the system 100 can be provide as a roll 145. The roll 145 can include a center base 150, which allows the hanging strap 105, to be pulled from the roll 145 and cut to length.

In this embodiment, the layers can include a 1S clay coated wet strength paper 210 (such as 16pt Aqua-Kote or Carriercoat) laminated with silica threads 225 coated on both sides with compostable pressure sensitive adhesive 220 and corn-based film 205. The system 100 is designed for interior or exterior applications. It should be appreciated that the gauges and other dimensions provided herein are exemplary and other dimension can also be used.

In an exemplary embodiment, the first layer of the material roll 145 can comprise a paper stock layer 210. The paper stock layer 210 can comprise 16 pt (or other gauge) AuqaKote Paper stock, or other such field compostable paper stock. The paper stock layer 210 is followed by silica threads 225, the hotmelt adhesive 220, and the PSA layer 205.

It should be appreciated that the silica threads 225 can comprise numerous silica threads laminated between the wet strength paper 210 and PLA film 205. The final layer is the PLA layer comprising a 1.6 mil Corn-based PLA layer. All the layers can be selected to be field compostable. In the embodiment illustrated in FIG. 2, the slot 115 is illustrated as perforated chads that can be removed to reveal the slot 115. All materials selected for the grow strap 105 can be selected to be easily shreddable, compostable and/or biodegradable.

FIG. 3 illustrates the exemplary engagement of the zip strap 120 to the hanging grow strap 105. As illustrated, the zip strap 120 can be inserted through slot 115 and then self-engaged in a loop 305. In exemplary embodiments, the loop 305 can be used to tutor a plant to climb the grow strap 105.

The disclosed systems describe a hanging strap 105 which can be used in covered greenhouses, outdoor facilities, or with other such vertical growing systems. Hanging straps 105 hang from a ceiling, line, beam, pole, wire, or the like, and the plants are wrapped around them. Zip straps 120 can be used to hold the plants in place until the vine grows. As the plant twists around the hanging strap additional zip straps and be added to train the vine up the strap. The hanging straps support all of the weight of the produce.

The disclosed hanging strap can be used for plants including, but not limited to, tomatoes, cucumbers, cantaloupes, watermelons, etc. The plant clings to the hanging strap which is configured to support the weight of the plant (up to 100 pounds). The zip straps are used to lightly retain or tutor, the branch/vine as it grows up the strap by wrapping the plant around the strap.

At the end of the season, the hanging straps can be cut with a pole saw, or other such cutting device, dropping the plant vines and the strapping. After this operation, a commercial shredder like a hay chopper can pick up the field compostable soil sealing barrier along with all the plant matter and hanging straps. The remnants can be run through a shredder. Once shredded, they can either be placed in a bin or scattered back on the soil. The bin can be taken to a compost area to decompose.

Similarly, in certain embodiments, the soil sealing barrier 155 can be used in an indoor or outdoor plant growing environment. The soil sealing barrier 155 can be used in conjunction with the hanging strap 105, or it can be used independently to trap moisture in soil, prevent weed growth, and to facilitate plant growth.

FIG. 4 illustrates another embodiment of a soil sealing and weed prevention barrier 400, in accordance with the disclosed embodiments. In this embodiment, the soil sealing barrier comprises, clay coated wet strength paper 405, with a clay coated side 410 facing toward the soil. A natural oil coating 415 (e.g.,, peppermint oil, citronella oil, etc.) can be applied to the wet strength side 420 of the paper 405. The oil coating can be selected to repel pests and provide additional moisture repellant properties. It should be appreciated that the oil coating can be provided in other embodiments as well. The soil sealing barrier 400 can further include a series of cutouts 425 so that the plant can grow through the cutout 425. The soil sealing and weed prevention barrier 400, is configured to trap moisture in the soil to enhance plant growth. The soil sealing and weed prevention barrier 400 further prevents the growth of unwanted weeds proximate to the plants. All materials selected for the soil sealing and weed prevention barrier 400 can be selected to be easily shreddable, compostable and/or biodegradable.

FIG. 5 provides an image of a soil sealing and weed prevention barrier 500 in accordance with the disclosed embodiments. As illustrated the soil sealing barrier 505 is installed over the ground 520, where a plant 510 will be planted. Cutouts 515 are cut in the soil sealing and weed prevention barrier 500, so that plants 510 can grow through the cutouts. The soil sealing and weed prevention barrier 500 is meant to illustrates one example of a soil sealing weed prevention barrier, such as soil sealing barrier 155, or soil sealing and weed prevention barrier 400.

FIG. 6 illustrates a method 600 for growing vertical plants in accordance with the disclosed systems (e.g. the embodiments illustrated in FIGS. 1-5). The method 600 starts at step 605.

At 610, hanging straps can be dispensed from the roll, and cut to length. Tt step 615 the hanging strap can be attached to the ground mount, where the plant is or will be planted. The hanging straps can then be connected to a top side support at step 620. This could be beams in an indoor green house, an indoor support structure, hanging wires in an outdoor grow environment, or other such support.

Once the hanging straps are installed, plants planted below the hanging strap can be trained to grow along the hanging straps at step 625. Field compostable soil sealing barriers can be installed on the ground below the hanging straps. The soil sealing barriers can be configured with holes that allow the plant to grow out of the soil and up along the hanging straps above. In certain embodiments, the hanging strap can be aligned with the hole at the bottom of the field compostable soil sealing barrier, which can be placed to allow the germinating plant, or sprout to grow. The plant grows through the hole and clings to the hanging strap as it grows. At step 630 zip straps can be used to tutor the plant to the hanging strap. Additional compostable zip straps can be added as the plant continues to grow along the hanging strap.

At step 635, the plant can be harvested. Once the harvest is complete, at step 640, the hanging straps can be cut from the supports creating a mixed heap of plant matter, field compostable soil sealing barriers, and the hanging strap system. At step 645, the mix can be shredded. Shredding is possible because the hanging strap and the soil sealing barrier does not include any metal or plastic components, and is configured to be field compostable. The shredded remnants can then be used for composting or otherwise disposed at 650. The method ends at 655.

This embodiments disclosed herein are intended to greatly simplify removal of grow support components and can be configured with compostable materials. This offers a major advantage over hydrocarbon based plastic waste, or metal waste mixed with plant matter that must be collected from fields before disposal. The disclosed embodiments are renewable, and can be made from clay bound to wet strength paper with a thin corn film PLA adhered to the wet strength paper side, to aid in water repellence and strength. The system is intended for single season use, and provides easy collection and shredding (along with plant matter).

Based on the foregoing, it can be appreciated that a number of embodiments, preferred and alternative, are disclosed herein. For example, in certain embodiments, a system comprises a hanging strap the hanging strap further comprising: a plurality of layers, at least one slot formed in a body of the hanging strap, and a field compostable soil sealing barrier. In an embodiment, the plurality of layers comprise: a carrierboard, silica threads laminated on the carrierboard with a compostable pressure sensitive adhesive, and a corn-based film. In an embodiment, the carrierboard comprises an Aqua-Kote or Carrierboard. In an embodiment, the field compostable soil sealing barrier comprises paper stock, a corn based PLA film, and a hotmelt adhesive. In an embodiment, the field compostable soil sealing barrier further comprises at least one hole formed in the field compostable soil sealing barrier. In an embodiment, the system further comprises a zip strap configured to engage the at least one slot.

In an embodiment a system comprises a hanging strap the hanging strap further comprising a connector end configured to engage with an overhead structure; a plurality of biodegradable and/or compostable layers; and a plurality of slots formed in a body of the hanging strap. In an embodiment, the plurality of biodegradable and/or compostable layers comprise a carrierboard, silica threads laminated on the carrierboard with a compostable pressure sensitive adhesive, and a corn-based film. In an embodiment, the carrierboard comprises Aqua-Kote or Carrierboard. In an embodiment, the system further comprises a zip strap configured to engage the at least one slot. In an embodiment, the zip strap further comprises a biodegradable and/or compostable material.

In an embodiment, the system further comprises a field compostable soil sealing barrier comprising a plurality of biodegradable and/or compostable layers. In an embodiment, the field compostable soil sealing barrier comprises paper stock, a corn based PLA film, and a hotmelt adhesive. In an embodiment, the field compostable soil sealing barrier comprises paper stock, and a clay coating. In an embodiment, the field compostable soil sealing barrier further comprises a natural oil coating applied to at least one of the plurality of biodegradable and/or compostable layers. In an embodiment, the system further comprises at least one cutout formed in the field compostable soil sealing barrier.

In another embodiment, a system comprises a field compostable soil sealing barrier comprising a plurality of biodegradable and/or compostable layers. In an embodiment, the field compostable soil sealing barrier comprises paper stock, a corn based PLA film, and a hotmelt adhesive. In an embodiment, the field compostable soil sealing barrier comprises paper stock and a clay coating. In an embodiment, the field compostable soil sealing barrier further comprises a natural oil coating applied to at least one of the plurality of biodegradable and/or compostable layers. In an embodiment, the system comprises at least one cutout formed in the field compostable soil sealing barrier.

In another embodiment, a system comprises a hanging strap the hanging strap further comprising: a connector end configured to engage with an overhead structure, a plurality of layers, a plurality of slots formed in a body of the hanging strap, and a field compostable soil sealing barrier with at least one cutout formed in the field compostable soil sealing barrier; and a zip strap configured to engage the at least one slot. In an embodiment, the plurality of layers comprise a carrierboard, silica threads laminated on the carrierboard with a compostable pressure sensitive adhesive, and a corn-based film. In an embodiment, the field compostable soil sealing barrier comprises paper stock, a corn based PLA film, and a hotmelt adhesive. In an embodiment, the field compostable soil sealing barrier comprises paper stock and a clay coating. In an embodiment, the field compostable soil sealing barrier further comprises a natural oil coating applied to at least one of the plurality of biodegradable and/or compostable layers.

It will be appreciated that variations of the above-disclosed and other features and functions, or alternatives thereof, may be desirably combined into many other different systems or applications. Also, it should be appreciated that various presently unforeseen or unanticipated alternatives, modifications, variations, or improvements therein may be subsequently made by those skilled in the art which are also intended to be encompassed by the following claims.

What is claimed is:

1. A system comprising:
a hanging strap the hanging strap further comprising:
a connector end configured to engage with an overhead structure;
a plurality of compostable layers; and
a plurality of slots formed in a body of the hanging strap.

2. The system of claim 1 where the plurality of compostable layers comprise:
a carrierboard;
silica threads laminated on the carrierboard with a compostable pressure sensitive adhesive; and
a corn-based film.

3. The system of claim 2 wherein the carrierboard comprises:
Aqua-Kote; or
Carrierboard.

4. The system of claim 1 further comprising:
a zip strap configured to engage the at least one slot.

5. The system of claim 1 wherein the zip strap further comprises:
a compostable material.

6. The system of claim 1 further comprising:
a field compostable soil sealing barrier comprising a plurality of compostable layers.

7. The system of claim 6 wherein the field compostable soil sealing barrier comprises:
paper stock;
a corn based PLA film; and
a hotmelt adhesive.

8. The system of claim 6 wherein the field compostable soil sealing barrier comprises:
paper stock; and
a clay coating.

9. The system of claim 6 wherein the field compostable soil sealing barrier further comprises:
a natural oil coating applied to at least one of the plurality of compostable layers.

10. The system of claim 6 further comprising:
at least one cutout formed in the field compostable soil sealing barrier.

11. The system comprising:
a field compostable soil sealing barrier comprising a plurality of compostable layers.

12. The system of claim 11 wherein the field compostable soil sealing barrier comprises:
paper stock;
a corn based PLA film; and
a hotmelt adhesive.

13. The system of claim 11 wherein the field compostable soil sealing barrier comprises:
paper stock; and
a clay coating.

14. the system of claim 11 wherein the field compostable soil sealing barrier further comprises:
a natural oil coating applied to at least one of the plurality of compostable layers.

15. The system of claim 11 further comprising:
at least one cutout formed in the field compostable soil sealing barrier.

16. A system comprising:
a hanging strap the hanging strap further comprising:
a connector end configured to engage with an overhead structure;
a plurality of layers;
a plurality of slots formed in a body of the hanging strap; and
a field compostable soil sealing barrier with at least one cutout formed in the field compostable soil sealing barrier; and
a zip strap configured to engage the at least one slot.

17. The system of claim 1 where the plurality of layers comprise:
a carrierboard;
silica threads laminated on the carrierboard with a compostable pressure sensitive adhesive; and
a corn-based film.

18. The system of claim 16 wherein the field compostable soil sealing barrier comprises:
paper stock;
a corn based PLA film; and
a hotmelt adhesive.

19. The system of claim 16 wherein the field compostable soil sealing barrier comprises:
paper stock; and
a clay coating.

20. The system of claim 19 wherein the field compostable soil sealing barrier further comprises:
a natural oil coating applied to at least one of the plurality of compostable layers.
